(19) United States
(12) Patent Application Publication
(10) Pub. No.: US 2011/0111144 A1
(43) Pub. Date: May 12, 2011

(54) INK JET RECORDING MEDIUM AND PROCESS FOR PRODUCING THE INK JET RECORDING MEDIUM

(76) Inventors: Masafumi Wasai, Tokyo (JP); Takayuki Sato, Tokyo (JP); Masaya Tosaka, Tokyo (JP); Kei Takigawa, Tokyo (JP)

(21) Appl. No.: 12/934,486

(22) PCT Filed: Mar. 25, 2009
(86) PCT No.: PCT/JP2009/055929

§ 371 Date: Jan. 10, 2011

(30) Foreign Application Priority Data
Mar. 27, 2008 (JP) 2008 083119

(51) Int. Cl. B41M 5/50; B05D 1/36

(52) U.S. Cl. 428/32.37; 428/32.34; 427/407.1

(57) ABSTRACT

An inkjet recording medium comprising an ink receiving layer formed by applying a coating layer containing a pigment and a binder to at least one side of a support having air permeability, and applying a coagulation solution for coagulating the binder on a surface of the coating layer by a coagulation cast coating method, wherein a boron compound, a cationic resin and cationic colloidal silica contained in the coagulation solution exist on the surface of the ink receiving layer.

### FIELD OF THE INVENTION

The present invention relates to a gloss inkjet recording medium suitable for inkjet recording and a method of manufacturing the same.

### DESCRIPTION OF THE RELATED ART

An inkjet recording medium comprises an ink receiving layer containing a porous pigment such as silica or alumina, and a binder on a surface of a support such as paper such that ink droplets are fixed on the ink receiving layer. Along with the remarkable progress in inkjet printers and widely spread digital cameras in recent years, a quality level required for the inkjet recording medium is demanding year after year. In particular, in a very high quality inkjet recording medium approaching the quality of the conventional silver halide photographs, quality level is highly required, and the technology development is enormously encouraged.

Such a gloss inkjet recording medium is commonly produced by a cast coating method using a cast coater in view of manufacturing costs. The cast coating method involves applying a coating color containing a pigment and a binder as major components to a support to form a coating layer, and providing the coating layer with a gloss finish using a cast drum. The gloss coating layer becomes the ink receiving layer. Three types of cast coating methods are generally known: (1) a wet casting (direct) method in which the coating layer in a wet state is pressed against a heated specular finish surface of a drum and then dried, (2) a re-wetting method in which the coating layer in a wet state is dried or semi-dried, then swelled and plasticized with a re-wetting agent, and is pressed against a heated specular finish surface of a drum and then dried, and (3) a gel casting (coagulation) method in which the coating layer in a wet state is gelled by a coagulation treatment, and is pressed against a heated specular finish surface of a drum and then dried. The principle of each method is the same in that the coating layer in a wet state is pressed against a specular finish surface to provide to the surface of the coating layer with gloss.

Quality characteristics required for the gloss inkjet recording medium involves a high-gloss recording medium surface, a high optical density, no ink overflow or no bleeding, less uneven printing (uneven contrasting density), weatherability or the like. In order to enhance these characteristics, the ink receiving layer is improved. For example, it is known that a technology in which one or more ink receiving layers are used, and at least one of which contains colloid particles having a mean particle diameter of 300 nm or less and a cationic resin (see, for example, Patent Literature 1). Also, it is known that a technology using colloidal silica having a primary particle diameter of 30-100 nm in a cast coating layer (see, for example, Patent Literature 2).

In addition, a technology is reported that a boron compound, colloidal silica and resin are added to the coagulation agent, when the coagulation agent that can be coagulated with the adhesive in the coating layer is applied to form a ink receiving layer by a coagulation method (see, for example, Patent Literature 3).
[Patent Literature 1] Unexamined Japanese Patent Publication (Kokai) Hei9-263039
[Patent Literature 2] Unexamined Japanese Patent Publication (Kokai) 2005-35169
[Patent Literature 3] Unexamined Japanese Patent Publication (Kokai) 2002-166645

### PROBLEMS TO BE SOLVED BY THE INVENTION

In the case of the technology described in Patent Literatures 1 and 2, there is a room for improvement in view of providing the recording medium with high gloss, and there is a problem that the optical density may be decreased due to the great mean particle diameter of the pigment contained in the ink receiving layer when inkjet recording is conducted using a dye ink.

In the case of the technology described in Patent Literature 3, although the optical density of the dye ink is enhanced due to colloidal silica having a small mean particle diameter on the surface of the ink receiving layer, no cationic resin for fixing ink exists on the surface of the ink receiving layer, resulting in poor water resistance.

In the technology described in Patent Literature 3, if the colloidal silica in the coagulation agent is anionic, it is aggregated with the cationic resin and therefore no cationic resin can be added. As a result, an ink fixing property becomes worse to decrease an ink absorption property and water resistance. If the colloidal silica is cationic, it is aggregated with borate and therefore no borate can be added to the coagulation agent. As a result, a coagulation effect becomes insufficient to worse the operability.

Therefore, the object of the present invention is to provide an inkjet recording medium having excellent gloss and high optical density when a dye ink is used for inkjet recording, as well as excellent ink absorption performance and water resistance.

### SUMMARY OF THE INVENTION

Through diligent studies, the present inventors found that the above-described problem can be solved by providing stably cationic colloidal silica near the surface of the ink receiving layer.

That is, the present invention provides an inkjet recording medium comprising an ink receiving layer formed by applying a coating layer containing a pigment and a binder to at least one side of a support having air permeability, and applying a coagulation solution for coagulating the binder on a surface of the coating layer by a coagulation cast coating method, wherein a boron compound, a cationic resin and cationic colloidal silica contained in the coagulation solution exist on the surface of the ink receiving layer.

Preferably, the coagulation solution contains 0.5 to 4% by weight of the cationic colloidal silica.

Preferably, the primary particle diameter of the cationic colloidal silica is smaller than the primary particle diameter of the pigment.

Preferably, the pigment in the coating layer contains colloidal silica, the binder contains polyvinyl alcohol, the cationic colloidal silica in the coagulation solution has a primary particle diameter of 10 to 50 nm, and the boron compound is boric acid.

Preferably, gloss at 20 degree on the surface of the ink receiving layer is 20% or more.

Preferably, the colloidal silica in the coating layer is anionic.

Preferably, the pigment in the coating layer further comprises wet synthetic amorphous silica having the specific surface area of 100-300 m²/g, and the mean secondary particle diameter of 1 to 4 μm.

Preferably, the coagulation solution contains a release agent.

Preferably, the support contains the rosette type precipitated calcium carbonate having the ash content of 3-25% by weight according to JIS-P8251.

The present invention also provides a method of manufacturing an inkjet recording medium comprising the steps of: applying a coating color for an ink receiving layer having a pH of 7 to 10 containing colloidal silica as a pigment and polyvinyl alcohol as a binder on at least one side of a support having air permeability to form a coating layer; applying a coagulation solution having a pH of 1 to 4 containing 2-15% by weight of the cationic colloidal silica having a primary particle diameter of 10 to 50 nm, 1 to 10% by weight of boric acid and a cationic resin while the coating layer is in a wet state; and forming the ink receiving layer by a coagulation cast coating method.

According to the present invention, there is provided an inkjet recording medium having high gloss, high optical density when a dye ink is used for inkjet recording, excellent ink absorption performance and water resistance, since cationic colloidal silica exists near the surface of the ink receiving layer.

### BRIEF DESCRIPTION OF THE DRAWING

FIG. 1 is an electron micrograph showing a shape of secondary particles in rosette type precipitated calcium carbonate.

### DESCRIPTION OF THE PREFERRED EMBODIMENTS

Embodiments of the present invention are explained below. The inkjet recording medium according to the present invention comprises an ink receiving layer formed by applying a coating layer containing a pigment and a binder to at least one side of a support having air permeability, and applying a coagulation solution for coagulating the binder on a surface of the coating layer by a coagulation cast coating method.

### (Support)

The support for use in the present invention can be any material as long as it has air permeability to permeate water vapor produced on the cast drum upon cast coating. A paper (paper support) including a coating paper and a non-coating paper is preferably used. As raw material pulp of the paper support, chemical pulp (for example, bleached or unbleached softwood kraft pulp, bleached or unbleached hardwood kraft pulp), mechanical pulp (for example, ground pulp, thermomechanical pulp and chemithermomechanical pulp), and de-inked pulp can be used alone or in combination in any ratio. The raw material pulp preferably comprises softwood pulp. A use of softwood pulp in the paper support enhances the strength of the base paper, and tends to increase gloss in the ink receiving layer. However, if a large amount of softwood pulp is used, the surface properties of the paper support may decline. The content of softwood pulp is preferably 30% by weight or less based on the total amount of the pulp. The pH of the paper support may be acidic, neutral and alkaline.

Preferably, the support contains rosette type precipitated calcium carbonate as a loading filler. The rosette type precipitated calcium carbonate is made by aggregating radially primary particles of spindle like precipitated calcium carbonate to form rosette type secondary particles. Specific examples include ALBACAR-HO, ALBACAR-5970 and ALBACAR-LO sold by Specialty Minerals Inc. The term “radially” means that each primary particle grows radially in a longitudinal direction from the neighborhood of a center of each secondary particle.

The precipitated calcium carbonate is excellent in view of manufacturing costs and operability. Also, high opacity can be provided by adding only a small amount of precipitated calcium carbonate. When the support contains a high amount of the rosette type precipitated calcium carbonate, the opacity of the support is significantly enhanced to effectively prevent strike-through of inkjet recording due to the special shape of the rosette type precipitated calcium carbonate. The rosette type precipitated calcium carbonate has a higher specific surface area than that of conventional precipitated calcium carbonate such that the base paper (support) having excellent ink absorption performance is obtained. Especially when the ink receiving layer has less coating weight, the use of the rosette type precipitated calcium carbonate provides a great deal of benefits.

The mean particle diameter of the rosette type precipitated calcium carbonate is preferably 1.0 μm to 5.0 μm. The mean particle diameter is measured by laser diffraction and scattering method using, for example, “Mastersizer 2000” manufactured by Sysmex Corporation. When the mean particle diameter of the rosette type precipitated calcium carbonate is less than 1.0 μm, light permeability is enhanced to decrease the opacity of the paper support. As a result, the printed image may be seen through the rear surface of the recording paper, or strike-through may occur. When the mean particle diameter of the rosette type precipitated calcium carbonate exceeds 5.0 μm, the rosette type precipitated calcium carbonate as the loading filler is nonuniformly distributed to decrease the opacity of the paper support, which may leads to strike-through and decreased quality stability.

The rosette type precipitated calcium carbonate has preferably oil absorption of 90-300 ml/100 g, and more preferably 90-140 ml/100 g. When the oil absorption of the rosette type precipitated calcium carbonate is less than 90 ml/100 g, the ink absorption performance of the resulting inkjet recording medium declines. When the oil absorption of the rosette type precipitated calcium carbonate exceeds 300 ml/100 g, the absorption performance of the paper support may becomes too great to permeate only the binder component into the base paper, when the coating color for the ink receiving layer is applied. As a result, the surface strength of the ink receiving layer declines, and powder may drop when trimming.

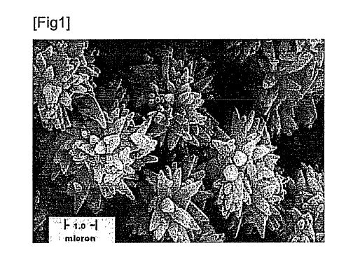

FIG. 1 is an electron micrograph showing an example of the rosette type precipitated calcium carbonate (secondary particles) dispersed in the liquid. In the FIGURE, the bottoms of the primary particles are aggregated and the primary particles grow radially to their tips. The primary particles have some large wide (diameter) bottoms and become thin toward the tips. In the FIGURE, the micron means μm.

When the ink receiving layer is formed on the base paper containing rosette type precipitated calcium carbonate as the loading filler by a cast coating method, gloss at 20 degree according to JIS-Z8741 on surface of the ink receiving layer is enhanced as compared with that formed on the paper support containing no rosette type precipitated calcium carbonate as a loading filler. Although not wishing to be bound by any theory, the reason is believed as follows:

When the rosette type precipitated calcium carbonate is added to the base paper, the density of the paper support decreases to be bulky and improve cushioning characteristics. When the coating layer for the ink receiving layer is pressed to the cast drum upon the cast coating, the ink receiving layer is easily in close contact with the surface of the cast drum. As a result, it is believed that the high-gloss ink receiving layer can be obtained. When the value of gloss at 20 degree is high, it can provide excellent gloss. In the present invention, the gloss at 20 degree is preferably 20% or more. Also, the high image clarity leads to high gloss. In the present invention, the image clarity is preferably 50% or more, and more preferably 70% or more. Preferably, the density of the paper support is 0.8 g/cm³ or less.

The ash content of the rosette type precipitated calcium carbonate in the paper support according to JIS-P8251 is preferably 3-25% by weight, and more preferably 10-20% by weight. The high ash content of the rosette type precipitated calcium carbonate in the paper support significantly improve gloss on the surface of the ink receiving layer formed by a cast coating method, and the ink absorption performance upon printing.

When the ash content of the rosette type precipitated calcium carbonate is less than 3% by weight, the gloss and the ink absorption performance may not be so improved. The high ash content of the rosette type precipitated calcium carbonate improves the gloss and the ink absorption performance. When the ash content exceeds 25% by weight, powder may drop and the strength of the paper support may be decreased. Accordingly, in light of the balance between manufacturing costs and its effectiveness, the ash content is preferably not exceeding 25% by weight.

According to JIS-P8251, the ash content is expressed by percentage of a residue weight of ash after burning at a temperature of 525+/−25° C. to dry weight of a sample.

Known loading fillers including hydrated silica, white carbon, talc, kaolin, clay, calcium carbonate (other than the rosette type precipitated calcium carbonate), titanium oxide, synthetic resin particles and the like can be selected and used in combination with the rosette type calcium carbonate as needed, so long as they do not interfere with the effect of the present invention. The amount of the loading filler other than the rosette type calcium carbonate is preferably 30% by weight or less based on the total amount of the loading filler in the paper support. More preferably, no loading filler other than the rosette type calcium carbonate is included.

Preferably, the paper support has air permeability of 1000 seconds or less from the standpoint of the production efficiency of the inkjet recording medium, and has desirably Stockigt size degree of 10 seconds or more from the standpoint of the coating property.

The liquid containing various additives including a water soluble polymer additive can be applied to the paper support on-machine or off-machine using a tab size, a size press, a gate roll coater, a film transfer coater and the like.

Examples of the water soluble polymer additive includes starch, starch derivatives such as cationic starch, oxidized starch, etherified starch and phosphate esterified starch; polyvinyl alcohol derivatives such as polyvinyl alcohol, carboxy modified polyvinyl alcohol; cellulose derivatives such as carboxymethyl cellulose, hydroxymethyl cellulose, hydroxyethyl cellulose and cellulose sulfate; water soluble natural polymers such as gelatin, casein and soy protein; water soluble polymers such as sodium polyacrylate, a sodium salt of a styrene-maleic anhydride copolymer, sodium polystyrene sulfonate and a maleic anhydride resin; and water soluble polymer adhesives including thermosetting synthetic resins such as a melamine resin and a urea resin.

Examples of the sizing agent as other additives include a dispersion of petroleum resin emulsion, an ammonium salt of an alkyl ester of a styrene-maleic anhydride copolymer, an alkyl ketene dimer, alkenyl succinic anhydride, a styrene-butadiene copolymer, an ethylene-vinyl acetate copolymer, polyethylene and polyvinylidene chloride. Examples of the antistatic agent as other additives include inorganic electrolytes such as sodium chloride, calcium chloride and sodium sulfate, and hygroscopic substances such as glycerin and polyethylene glycol. Examples of the pigment as other additives include clay, kaolin, talc, barium sulfate, titanium oxide, calcium carbonate, hydrated silica, white carbon and synthetic resin fine particles. Examples of the pH regulator as other additives include hydrochloric acid, sodium hydroxide and sodium carbonate. Other additives such as a dye, a fluorescent whitening agent, an antioxidant and an ultraviolet ray absorption agent can be used in combination.

### (Pigment in the Ink Receiving Layer)

As the pigment in the ink receiving layer (the coating layer turns into the ink receiving layer by the coagulation cast coating method; for convenience, the coating layer and the ink receiving layer are used interchangeably), colloidal silica is preferable especially in view of color development and gloss. In view of the ink absorption performance, synthetic amorphous silica is preferably used in combination with the colloidal silica.

The colloidal silica used in the ink receiving layer is preferably anionic. This is because the colloidal silica in the coagulation solution is cationic as described later. And it is preferable that the anionic colloidal silica for inducing the aggregation reaction to improve the coagulation property is used in the ink receiving layer. The anionic colloidal silica has a primary particle diameter of preferably 5-100 nm, and more preferably 20-70 nm. When the primary particle diameter of the anionic colloidal silica is less than 5 nm, the color development of the ink may be lowered upon the printing with the ink jet printer using the pigment ink. When the primary particle diameter of the anionic colloidal silica exceeds 100 nm, the space between particles is increased to improve the ink absorption performance of the ink receiving layer. However, since the opacity is increased, the color development upon the ink jet recording with the dye ink may be decreased.

As the pigment in the ink receiving layer, the synthetic amorphous silica can be used in addition to the colloidal silica. The synthetic amorphous silica is roughly classified into wet type silica and fumed silica depending on the production method.

The synthetic amorphous silica produced by a wet process (hereinafter referred to as “wet synthetic amorphous silica”) has lower pigment transparency than fumed silica, but has excellent coating color stability when polyvinyl alcohol is used as a binder in the ink receiving layer. Also, the wet synthetic amorphous silica has good dispersibility as compared with the fumed silica including no internal void, and it is possible to increase the coating color concentration. Accordingly, the percentage of the pigment in the ink receiving layer (to the binder) can be high to increase the absorption performance of the ink receiving layer. Thus, the ink absorption performance and the color development of the dye ink can be improved. In terms of obtaining high gloss, the secondary particle diameter of the wet synthetic amorphous silica is preferably 1 to 5 μm. Preferably, the BET specific surface area of the wet synthetic amorphous silica is 100-300 m²/g. When the secondary particle diameter is less than 1 μm, the ink absorption performance is poor, and when it exceeds 4 μm, the gloss tends to be decreased.

In terms of obtaining a high transparent coating layer, the fumed silica may be used. Preferably, the fumed silica has a primary particle diameter of 4 to 30 nm, and has the BET specific surface area of 100-400 m²/g.

A weight ratio of the colloidal silica to the synthetic amorphous silica is preferably 10:90 to 60:40 (colloidal silica:synthetic amorphous silica). When the weight ratio of the colloidal silica is less than 10, the color development and gloss are poor. When the weight ratio of the colloidal silica exceeds 60, the ink absorption performance tends to be poor.

As other pigment in the ink receiving layer, known inorganic and organic particles can be used together with the silica. Examples of the other pigment include an alumina hydrate (alumina sol, colloidal alumina, pseudo-boehmite), alumina (α-type crystal alumina, O-type crystal alumina, γ-type crystal alumina), calcium carbonate, titanium oxide and the like. However, in view of the printing quality and gloss, the pigment preferably consists of the colloidal silica and the synthetic amorphous silica.

According to the present invention, the primary particle diameters of the pigment in the ink receiving layer and the cationic colloidal silica in the coagulation solution as described later can be measured by the BET method (nitrogen adsorption method). The secondary particle diameter can be measured by dynamic light scattering method (laser diffraction and scattering method).

### (Binder in the Ink Receiving Layer)

The binder in the ink receiving layer preferably contains polyvinyl alcohol that is an aqueous binder resin having a coagulation effect. Other aqueous binder resins may be used together with polyvinyl alcohol to assure the strength of the ink receiving layer. The term “aqueous” means that the resin is dissolved or dispersed and stabilized in a medium consisting of water or water and a minor amount of an organic solvent (water soluble and/or water dispersible resin emulsion). The aqueous binder resin means an aqueous resin or a water dispersible resin. The aqueous binder is dissolved or dispersed as particles in the coating color which is applied to the paper support. After coating and drying, the aqueous binder acts on the pigment to form the ink receiving layer.

Examples of other aqueous binder resins include polyvinyl pyrrolidone; urethane resin derived from urethane resin emulsion; starches such as oxidized starch, esterified starch and the like; cellulose derivatives such as carboxymethyl cellulose, hydroxyethyl cellulose; casein; gelatin; soy protein; styrene-acrylic resin and their derivatives; styrene-butadiene resin latex; acrylic resin emulsion, vinyl acetate resin emulsion, vinyl chloride resin emulsion, urethane resin emulsion, alkyd resin emulsion and their derivatives. These aqueous binder resins can be used by mixed with polyvinyl alcohol.

In the present invention, partially saponified polyvinyl alcohol is preferably used. The polyvinyl alcohol is preferably added in amount of 5 to 30 parts by weight based on 100 parts by weight of the pigment in the ink receiving layer. As long as the needed strength of the ink receiving layer is provided, the type of the binder should not be especially limited.

The ink receiving layer contains the pigment and the binder described above. Other components such as a thickener, an antifoaming agent, a foam inhibitor, a pigment dispersing agent, a mold release agent, a foaming agent, a pH adjusting agent, a surface sizing agent, a coloring dye, a coloring pigment, a fluorescent dye, an ultraviolet ray absorption agent, an antioxidant, a light stabilizer, a preservative, a water resistant additive, a dye fixing agent, a surfactant, a wet paper strengthening agent, a water retention agent, a cationic polymer electrolyte and the like can be added to the coating layer that is a precursor of the ink receiving layer within the ranges that do not adversely affect on the effect of the present invention.

A coating color for forming the ink receiving layer can be applied to the support using any coating method by selecting from a known on-machine or off-machine coater such as a blade coater, an air knife coater, a roll coater, a brush coater, a kiss coater, a squeeze coater, a curtain coater, a die coater, a bar coater, a gravure coater, a gate roll coater, a short dwell coater and the like.

The coating weight of the ink receiving layer can be appropriately controlled in so far as the coating color covers the surface of the support and sufficient ink absorption performance is obtained. Preferably, the coating weight of the ink receiving layer is 3-25 g/m² in terms of solid content from the standpoint of both sufficient recording density and ink absorption performance, and more preferably 5-20 g/m² from the standpoint of productivity. When the coating weight exceeds 25 g/m², the coating layer is not well released from the specular finish surface of the cast drum and may be adhered to the specular finish surface.

In the present invention, if the high coating weight is required in the ink receiving layer (coating layer), the ink receiving can be multilayered. An undercoat layer having various features including the ink absorption performance, adhesion properties and the like may be disposed between the paper support and the ink receiving layer. Moreover, a backcoat layer having various features including the ink absorption performance, writing properties, printability and the like may be disposed on the opposite surface of the paper support on which ink receiving layer is disposed.

### (Formation of the Ink Receiving Layer)

According to the present invention, gloss is provided by forming the ink receiving layer, which is the outermost layer, using a coagulation cast coating method. The coagulation cast coating method is conducted as follows, for example. A coating color for an ink receiving layer is applied to a support to form a coating layer. Then, a coagulation solution for coagulating a binder (especially aqueous binder) in the coating color is applied to the coating layer in a wet state to be gelled, which is pressed against a heated specular finish surface and dried. The coagulation cast coating method is capable of adding surface appearance and gloss which are comparable to silver halide photographs to the ink receiving layer.

When the coagulation solution is applied while the coating layer is in a dry state, the specular finish surface is difficult to be taken out, minor asperities on the surface of the resulting ink receiving layer are increased, and gloss comparable to that of silver halide photographs cannot be easily attained. Especially when polyvinyl alcohol is used as the aqueous binder in the ink receiving layer and borate is used as the coagulation agent, appropriate hardness is easily attained upon coagulation. As a result, good gloss can be added to the ink receiving layer and the operability can also be good. However, according to the present invention, since the cationic colloidal silica is added to the coagulation solution as described later, borate, if used in the coagulation solution, is aggregated with the cationic colloidal silica. Accordingly, the use of borate may inhibit the preparation of the coagulation solution.

In the present invention, it is preferable that the coagulation solution contains boric acid without adding borate, and is coagulated by a cross-linking reaction with polyvinyl alcohol in the ink receiving layer to provide the ink receiving layer with good printing quality and high gloss. When the coating color for the ink receiving layer contains anionic colloidal silica, the coagulation effect by the aggregation reaction between the anionic coating color and the cationic coagulation solution can provide the ink receiving layer with excellent printing quality and high gloss, and realize a stable operation.

### (Component in the Coagulation Solution)

As described above, the coagulation solution for use in the present invention preferably contains the cationic colloidal silica, boric acid and cationic resin, but no borate.

### (Cationic Colloidal Silica)

When the cationic colloidal silica is added to the coagulation solution, the cationic colloidal silica is attached (exists) near the surface of the ink receiving layer by a cast coating method. When the fine cationic colloidal silica having a primary particle diameter of 10-50 nm is provided on the surface of the ink receiving layer, the optical density is improved when the dye ink is used for printing. In addition, since the fine cationic colloidal silica having a primary particle diameter of 10-50 nm is provided on the outermost surface of the ink receiving layer, the surface of the ink receiving layer becomes smooth and has improved gloss.

The cationic colloidal silica is colloidal silica having highly electropositive charged particle surfaces. The cationic colloidal silica is obtained by reacting multivalent metal ions such as an aluminum ion, a magnesium ion, a calcium ion or a zirconium ion with following colloidal silica. This colloidal silica is obtained, for example, by double decomposition of sodium silicate with acid or by heating and aging silica sol through ion-exchange resin layer. For example, Examined Japanese Patent Publication Sho 47-26959 discloses cationic colloidal silica treated with aluminum.

Commercially available cationic colloidal silica includes LUDOX CL and LUDOX CL-P sold by Grace & Co. Two or more types of cationic colloidal silica may be used in combination.

From the standpoint of improving gloss and transparency of the ink receiving layer, the cationic colloidal silica has a primary particle diameter of 10 to 50 nm. When the primary particle diameter of the cationic colloidal silica is less than 10 nm, the ink absorption performance of the dye ink may be poor, although the gloss of the ink receiving layer is excellent. When the primary particle diameter of the cationic colloidal silica is greater than 50 nm, the transparency of the ink receiving layer is decreased and the optical density may be decreased upon the dye ink printing. In order to compensate the ink absorption performance, the cationic colloidal silica having a primary particle diameter of more than 50 nm and different shapes such as a cluster and a cocoon (various types of amorphous aggregates) may be used together therewith.

From the standpoint of smoothing the outermost surface of the ink receiving layer and improving gloss, the primary particle diameter of the cationic colloidal silica is preferably smaller than the primary particle diameter of the pigment in the ink receiving layer. Thus, the fine cationic colloidal silica covers the outermost layer of the ink receiving layer to improve the gloss.

When two or more types of cationic colloidal silica having different primary particle diameters are used, the “primary particle diameter of cationic colloidal silica” is a weighted mean value of a primary particle diameter of each cationic colloidal silica based on the contents of the cationic colloidal silica. Similarly, when two or more types of pigments in the ink receiving layer having different primary particle diameters are used, the “primary particle diameter of the pigment” is a weighted mean value of a primary particle diameter of each pigment based on the contents of the pigment.

In addition, the cationic colloidal silica is aggregated with borate, therefore boric acid is preferably added to the coagulation solution to control the coagulation. In the case of boric acid is used, a control of the coagulation (hardness) is difficult as compared with the case in which a borate is used. When the anionic colloidal silica is added to the coating color for the ink receiving layer, and the pH of that is adjusted to 7 to 10 (at 30° C.), and the pH of the cationic coagulation solution is adjusted to 1 to 4 (at 30° C.), the coagulation property can be stably provided. As a result, even If boric acid is used, the coagulation can be easily controlled and the stable operation can be possible. When the pH of the coating color for the ink receiving layer exceeds 10 or the pH of the coagulation solution is less than 1, the piping of the coating apparatus may be melted. When the pH of the coating color for the ink receiving layer less than 7 or the pH of the coagulation solution exceeds 4, the coagulation reaction becomes insufficient and the stable operation may be difficult.

Preferably, the coagulation solution contains 2 to 15% by weight of the cationic colloidal silica. When the content of the cationic colloidal silica is less than 2% by weight, the gloss may be poor and the optical density may be decreased when the dye ink is used for printing. When the content of the cationic colloidal silica exceeds 15% by weight, an aggregate (deposit) may be produced to induce operation troubles.

As the pigments other than the cationic colloidal silica, an alumina hydrate (alumina sol, colloidal alumina, pseudo-boehmite), alumina (α-type crystal alumina, θ-type crystal alumina, γ-type crystal alumina) and the like may be used by mixing with the cationic colloidal silica. It is desirable that 50% by weight of other pigments be mixed with the cationic colloidal silica.

### (Boric Acid)

Preferably, the coagulation solution contains 1 to 10% by weight of boric acid. When the content of boric acid is less than 1% by weight, the coagulation action may be insufficient. When the content of boric acid exceeds 10% by weight, it may be impossible to dissolve boric acid in water and an aggregate (deposit) may be produced to induce operation troubles.

### (Cationic Resin)

When the cationic resin is added to the coagulation solution, the cationic resin is attached (exists) on the surface of the ink receiving layer by a coagulation cast coating method. The cationic resin causes the ink to be fixed to improve the optical density when the aqueous dye ink is used, and to enhance water resistance. Since both electrically positive cationic resin and cationic colloidal silica coexist in the coagulation solution, they will not be aggregated.

Examples of the cationic resin include polyamime sulfone, polyalkylene polyamine, a polyamine condensate, polyallylamine, polydiallylamine, polyvinylamine, polyethyleneimine, a dicyandiamide condensate, a cationic acrylic resin, a cationic urethane resin and the like, and may be used and selected alone or in combination. The content of the cationic resin in the coagulation solution is not especially limited, but 0.5 to 10% by weight is preferable. When the content of the cationic resin is less than 0.5% by weight, the ink fixing property may be decreased and the optical density of the printed image may be lowered. When the content of the cationic resin exceeds 10% by weight, the viscosity of the coagulation may be increased and the coating property may be decreased.

The method of applying the coagulation solution is not especially limited as long as it can be applied to the coating layer, and can be selected as required from known methods (such as roll, spray, curtain coating methods).

The applied weight of the coagulation agent (coagulation solution) is preferably 1-10 g/m² in terms of solid content. When the applied weight of the coagulation agent is less than 1 g/m², the coagulation action may be insufficient, and the gloss of the ink receiving layer may be insufficient. When the coating weight of the coagulation agent exceeds 10 g/m², the improvement in gloss of the ink receiving layer is saturated, and the solid content of the coagulation solution should be increased, which may leads to the problems as described later.

Preferably, the concentration of the coagulation solution is not less than 3% by weight to less than 30% by weight. When the concentration of the coagulation solution is less than 3% by weight, the applied amount of the coagulation agent to the coating layer (less than 1 g/m² in terms of solid content) becomes insufficient, and the coagulation action may be insufficient. When the concentration of the coagulation solution exceeds 10% by weight, the coagulation agent is difficult to be dissolved in water, and an aggregate (deposit) may be produced to induce operation troubles.

A release agent can be added to the coating layer and/or coagulation agent as needed. The release agent has a melting point preferably of 90-150° C., and more preferably of 95-120° C. Within above temperature range, the melting point of the release agent is almost equal to the temperature of the specular finish surface to maximize the performance of the release agent. Although the release agent is not especially limited as long as it has the above-mentioned properties, polyethylene type wax emulsion is preferably used. Although the content of the release agent in the coagulation solution is not especially limited, the coagulation solution preferably contains 0.1 to 5% by weigh of the release agent.

### EXAMPLES

The present invention is explained in further detail by presenting specific examples below, but the present invention is not limited by these examples. The terms “parts” and “%” refer to “parts by weight” and “% by weight” described herein, respectively, unless otherwise noted.

Examples 1 to 10 and Comparative Examples 1 to 6 contain a boron compound (specifically, borax) other than boric acid in the coagulation solution. Examples 11 to 16 and Comparative Example 11 to 15 contain no boron compound other than boric acid in the coagulation solution.

### Example 1

Rosette type precipitated calcium carbonate (ALBACAR-5970 manufactured by SMI Inc.) was added in an ash content of 20% as a loading filler to a pulp slurry comprising 90 parts of bleached hard wood kraft pulp (L-BKP) and 10 parts of bleached soft wood kraft pulp (N-BKP) and having freeness of 350 ml. 1.0 part of aluminum sulfate, 0.15 parts of AKD and 0.05 parts of a yield improving agent were further added thereto. The slurry was processed by a paper machine to make a base paper. On the base paper, 5% of starch and 0.2% of a surface sizing agent (AKD) were applied at a solid content of 1.5 g/m² when the base paper was made. Thus, a support having a coating weight of 180 g/m² is formed.

13 g/m² of the coating color A was applied to the support using a roll coater. While the coating layer was in a wet state, 2.0 g/m² of the coagulation agent B was applied and coagulated. Then, the coating layer was pressed to a heated specular finish surface via a press roll to transfer the specular surface, thereby providing an ink-jet recording medium having a coating weight of 195 g/m².

Coating color A: A coating color having a concentration of 25% was prepared by mixing, as pigments, 60 parts of colloidal silica (Quotron PL-2: a trade name manufactured by Fuso Chemical Co., Ltd., having a primary particle diameter of 20 nm), 20 parts of fumed synthetic amorphous silica (Aerosil 200V manufactured by Nippon Aerosil Co., Ltd., having a primary particle diameter of 12 nm), 20 parts of wet synthetic amorphous silica (Fine Seal X-37B manufactured by Tokuyama Corporation, having a secondary particle diameter of 2.6 μm); as a binder, 12 parts of polyvinyl alcohol (PVA224, a trade name manufactured by Kuraray Co., Ltd.); 1.5 parts of a fluorescent dye (BLANKOPHOR P liquid 0 1: a trade name manufactured by LANXESS K.K.); 0.5 parts of a mold release agent (Meikatex HP68: a trade name manufactured by Meisei Chemical Works, Ltd.); and 0.1 parts of an antifoaming agent (SN Defoamer 480: a trade name manufactured by San Nopco Ltd.).

A weighted mean value of a particle diameter of each pigment in the coating color A was 2.7 μm.

Coagulation agent B: A coagulation agent (solution) was prepared by mixing 2% of borax, 4% of boric acid (weight ratio of borax/boric acid=1/2, calculated by converting Na₂B₄O₇ and H₃BO₃), 2% of a cationic resin (Saftmer ST3300: a trade name manufactured by Mitsubishi Chemical Corporation), 0.5% of the cationic colloidal silica (LUDOX CL: a trade name manufactured by Grace & Co., having a primary particle diameter of 12 nm), 0.5 parts of a mold release agent (Meikatex HP68: a trade name manufactured by Meisei Chemical Works, Ltd.), and 0.01% of an antifoaming agent (SN Defoamer 480: a trade name manufactured by San Nopco Ltd).

### Example 2

An inkjet recording medium was produced in the same manner described in Example 1 with the exception that the amount of the cationic colloidal silica (LUDOX CL: a trade name manufactured by Grace & Co.) was changed to 1% in the coagulation agent B.

### Example 3

An inkjet recording medium was produced in the same manner described in Example 1 with the exception that the amount of the cationic colloidal silica (LUDOX CL: a trade name manufactured by Grace & Co.) was changed to 2% in the coagulation agent B.

### Example 4

An inkjet recording medium was produced in the same manner described in Example 1 with the exception that the amount of the cationic colloidal silica (LUDOX CL: a trade name manufactured by Grace & Co.) was changed to 3% in the coagulation agent B.

### Example 5

An inkjet recording medium was produced in the same manner described in Example 1 with the exception that the amount of the cationic colloidal silica (LUDOX CL: a trade name manufactured by Grace & Co.) was changed to 4% in the coagulation agent B.

### Example 6

An inkjet recording medium was produced in the same manner described in Example 1 with the exception that cationic colloidal silica (LUDOX CL-P: a trade name manufactured by Grace & Co., having a primary particle diameter of 22 nm) was used in the coagulation agent B in place of the cationic colloidal silica (LUDOX CL: a trade name manufactured by Grace & Co.).

### Example 7

An inkjet recording medium was produced in the same manner described in Example 6 with the exception that the amount of the cationic colloidal silica (LUDOX CL-P: a trade name manufactured by Grace & Co.) was changed to 1% in the coagulation agent B.

### Example 8

An inkjet recording medium was produced in the same manner described in Example 6 with the exception that the amount of the cationic colloidal silica (LUDOX CL-P: a trade name manufactured by Grace & Co.) was changed to 2% in the coagulation agent B.

### Example 9

An inkjet recording medium was produced in the same manner described in Example 6 with the exception that the amount of the cationic colloidal silica (LUDOX CL-P: a trade name manufactured by Grace & Co.) was changed to 3% in the coagulation agent B.

### Example 10

An inkjet recording medium was produced in the same manner described in Example 6 with the exception that the amount of the cationic colloidal silica (LUDOX CL-P: a trade name manufactured by Grace & Co.) was changed to 4% in the coagulation agent B.

### Comparative Example 1

An inkjet recording medium was produced in the same manner described in Example 1 with the exception that no cationic colloidal silica and no cationic resin were used in the coagulation agent B.

### Comparative Example 2

An inkjet recording medium was produced in the same manner described in Example 1 with the exception that no cationic colloidal silica was used in the coagulation agent B.

### Comparative Example 3

An inkjet recording medium was produced in the same manner described in Example 2 with the exception that no cationic resin was used in the coagulation agent B.

### Comparative Example 4

An inkjet recording medium was produced in the same manner described in Comparative Example 3 with the exception that cationic colloidal silica (LUDOX CL-P: a trade name manufactured by Grace & Co.) was used in the coagulation agent B in place of the cationic colloidal silica (LUDOX CL: a trade name manufactured by Grace & Co.).

### Comparative Example 5

An inkjet recording medium was produced in the same manner described in Comparative Example 3 with the exception that anionic colloidal silica (Quotron PL-2: a trade name manufactured by Fuso Chemical Co., Ltd.) was used in the coagulation agent B in place of the cationic colloidal silica (LUDOX CL: a trade name manufactured by Grace & Co.).

### Comparative Example 6

An inkjet recording medium was produced in the same manner described in Example 2 with the exception that anionic colloidal silica (Quotron PL-2: a trade name manufactured by Fuso Chemical Co., Ltd. was used in the coagulation agent B in place of the cationic colloidal silica (LUDOX CL: a trade name manufactured by Grace & Co.).

### Example 11

Rosette type precipitated calcium carbonate (ALBACAR-5970 manufactured by SMI Inc.) was added in an ash content of 20% as a loading filler to a pulp slurry comprising 90 parts of bleached hard wood kraft pulp (L-BKP) and 10 parts of bleached soft wood kraft pulp (N-BKP) and having Canadian Standard Freeness (CSF) of 350 ml. 1.0 part of aluminum sulfate, 0.20 parts of an alkyl ketene dimer (AKD) and 0.05 parts of a yield improving agent were further added thereto. The slurry was processed by a paper machine to make a base paper. On the base paper, 5% at a solid content of starch and 0.2% at a solid content of a surface sizing agent (AKD) were applied at a solid content of 1.5 g/m² when the base paper was made. Thus, a paper support having a coating weight of 180 g/m² is formed.

The coating color A2 was applied at a solid content of 12 g/m² to the paper support using a roll coater. While the coating layer was in a wet state, the coagulation agent B2 was applied at a solid content of 3.0 g/m² and coagulated. Then, the coating layer was pressed to a heated specular finish surface via a press roll to transfer the specular surface, thereby providing an ink-jet recording medium having a coating weight of 195 g/m².

<Coating color A2>: A coating color having a concentration of 25% and a pH of 8.3 was prepared by mixing, as pigments, 20 parts of colloidal silica (Quotron PL-3: a trade name manufactured by Fuso Chemical Co., Ltd., having a primary particle diameter of 30 nm), 10 parts of fumed synthetic amorphous silica (Aerosil 200V manufactured by Nippon Aerosil Co., Ltd., having a primary particle diameter of 12 nm), 70 parts of wet synthetic amorphous silica (Fine Seal X-37 manufactured by Tokuyama Corporation, having a secondary particle diameter of 2.3 μm); as a binder, 12 parts of polyvinyl alcohol (PVA217, a trade name manufactured by Kuraray Co., Ltd.); 1.5 parts of a fluorescent dye (BLANKOPHOR P liquid 0 1: a trade name manufactured by LANXESS K.K.); 0.5 parts of a mold release agent (Meikatex HP68: a trade name manufactured by Meisei Chemical Works, Ltd.); and 0.1 parts of an antifoaming agent (SN Defoamer 480: a trade name manufactured by San Nopco Ltd.).

<Coagulation Solution B2>: A coagulation solution was prepared by mixing 4% of boric acid, 1% of a cationic resin (Saftmer ST3300: a trade name manufactured by Mitsubishi Chemical Corporation), 2% of the cationic colloidal silica (LUDOX CL-P: a trade name manufactured by Grace & Co., having a primary particle diameter of 22 nm), 0.5 parts of a mold release agent (Meikatex HP68: a trade name manufactured by Meisei Chemical Works, Ltd.), and 0.1% of an antifoaming agent (SN Defoamer 480: a trade name manufactured by San Nopco Ltd).

### Example 12

An inkjet recording medium was produced in the same manner described in Example 11 with the exception that the amount of the cationic colloidal silica (LUDOX CL-P: a trade name manufactured by Grace & Co.) was changed to 7% in the coagulation solution B2.

### Example 13

An inkjet recording medium was produced in the same manner described in Example 11 with the exception that the amount of the cationic colloidal silica (LUDOX CL-P: a trade name manufactured by Grace & Co.) was changed to 15% in the coagulation solution B2.

### Example 14

An inkjet recording medium was produced in the same manner described in Example 11 with the exception that 6% of the cationic colloidal silica (LUDOX CL: a trade name manufactured by Grace & Co., having a primary particle diameter of 12 nm) was used in the coagulation solution B2 in place of the cationic colloidal silica (LUDOX CL: a trade name manufactured by Grace & Co., having a primary particle diameter of 22 nm).

### Example 15

An inkjet recording medium was produced in the same manner described in Example 11 with the exception that 1% of boric acid and 6% of the cationic colloidal silica (LUDOX CL: a trade name manufactured by Grace & Co.) were used in the coagulation solution B2.

### Example 16

An inkjet recording medium was produced in the same manner described in Example 15 with the exception that the amount of boric acid was changed to 10% in the coagulation solution B2.

### Comparative Example 11

An inkjet recording medium was produced in the same manner described in Example 11 with the exception that no cationic colloidal silica was used in the coagulation solution B2.

### Comparative Example 12

An inkjet recording medium was produced in the same manner described in Example 11 with the exception that the amount of the cationic colloidal silica (LUDOX CL-P: a trade name manufactured by Grace & Co.) was changed to 1% in the coagulation B2.

### Comparative Example 13

An inkjet recording medium was produced in the same manner described in Example 11 with the exception that the amount of the cationic colloidal silica (LUDOX CL-P: a trade name manufactured by Grace & Co.) was changed to 16% in the coagulation B2.

### Comparative Example 14

An inkjet recording medium was produced in the same manner described in Example 11 with the exception that anionic colloidal silica (ST-30: a trade name manufactured by Nissan Chemical Industries, Ltd.) was used in the coagulation solution B2 in place of the cationic colloidal silica (LUDOX CL: a trade name manufactured by Grace & Co.).

### Comparative Example 15

An inkjet recording medium was produced in the same manner described in Example 11 with the exception that anionic colloidal silica (Quotron PL-2: a trade name manufactured by Fuso Chemical Co., Ltd.) was used in the coagulation solution B2 in place of the cationic colloidal silica (LUDOX CL: a trade name manufactured by Grace & Co.).

### <Evaluation>

### 1. Dye Ink Optical Density

A predetermined pattern was recorded with the resulting inkjet recording medium using a dye inkjet printer (PM-970C: a trade name manufactured by Seiko Epson Corporation), and clarity on the recorded image was visually evaluated according to the following scales. When the evaluation is A or above, there is no practical problem.

⊙:a Very clear

### ◯: Clear

Δ: Slightly less clear
X: Not clear

### 2. Image Clarity

The image clarity of the resulting inkjet recording medium (at the ink receiving layer) was measured using an image clarity measuring device (Model: ICM-IDP manufactured by Suga Test Instruments, Co., Ltd.) according to JIS K7105. The measurement was conducted at measured angle of 60 degree and a comb wide of 2 mm in an MD direction of the paper. When the image clarity is 60% or more, the reflected image is clearly transferred and has excellent gloss. When the image clarity is less than 60%, the reflected image is not clearly transferred and has poor gloss.

### 3. Gloss at 20 Degree

Gloss at 20 degree on the non-printed area of the surface of the ink-receiving layer in the resulting inkjet recording medium was measured according to JIS-Z8741. A gloss meter (True GLOSS GM-26PRO manufactured by Murakami Color Research Laboratory) was used for measurement. When the gloss at 20 degree is 20% or more, there is no practical problem.

### 4. Water Resistance

A predetermined pattern was recorded with the resulting inkjet recording medium using a dye inkjet printer (PM-970C: a trade name manufactured by Seiko Epson Corporation), and a water droplet was dropped on the predetermined pattern, which was allowed to stand for 3 hours and visually evaluated for bleeding of ink according to the following scales. When the evaluation is A or above, there is no practical problem.

◯: Almost no bleeding
Δ: Some bleeding
X: Significantly bleeding

### 5. Stability of the Coating Color for the Ink Receiving Layer and the Coagulation Solution

After the coating color for the ink receiving layer and the coagulation solution were prepared, they were allowed to stand for 24 hours, and visually evaluated for the presence or absence of an aggregate. When the evaluation is A or above, there is no practical problem.

### ◯: Aggregate

Δ: Fine aggregate
X: No aggregate

### 6. Cast Coating Property

After the cast drum was used to continuously coat for 20,000 m in a continuous line, the cast drum was visually inspected for fogging, and was evaluated according to the following scales.

⊙: No fogging on the surface of the drum
◯: Some fogging on the surface of the drum, but almost no problem in a long running aptitude
Δ: Fogging on the surface of the drum, which is a problematic level
X: Much fogging on the entire surface of the drum

The results obtained are shown in Tables 1 and 2.

TABLE 1

| | Ink receiving layer | | | | | | | | | |
|---|---|---|---|---|---|---|---|---|---|---|
| | Pigment | Coagulation agent | | | | | | | | |
| | Weighted mean | Colloidal silica | | | Cationic | Evaluation | | | | |
| | particle | | Primaty particle | | resin | Stability of | Dye ink | Image | Gloss at | Water |
| | diameter | | diamter | Content | Content | coagulation | optical | clarity | 20 degree | resis- |
| | (μm) | Type | (nm) | (wt %) | wt %) | solution | density | (%) | (%) | tance |
| Ex. 1 | 27 | Cationic (LUDOX CL) | 12 | 0.5 | 2 | ⊚ | ◯ | 65 | 25 | ◯ |
| Ex. 2 | ″ | ″ | ″ | 1 | ″ | ◯ | ◯ | 68 | 30 | ◯ |
| Ex. 3 | ″ | ″ | ″ | 2 | ″ | ◯ | ⊚ | 71 | 30 | ◯ |
| Ex. 4 | ″ | ″ | ″ | 3 | ″ | Δ | ⊚ | 75 | 35 | ◯ |
| Ex. 5 | ″ | ″ | ″ | 4 | ″ | Δ | ⊚ | 82 | 28 | ◯ |
| Ex. 6 | ″ | Cationic (LUDOX CL-P) | 22 | 0.5 | 2 | ⊚ | ◯ | 63 | 22 | ◯ |
| Ex. 7 | ″ | ″ | ″ | 1 | ″ | ⊚ | ◯ | 65 | 25 | ◯ |
| Ex. 8 | ″ | ″ | ″ | 2 | ″ | ◯ | ⊚ | 70 | 30 | ◯ |
| Ex. 9 | ″ | ″ | ″ | 3 | ″ | ◯ | ⊚ | 72 | 32 | ◯ |
| Ex. 10 | ″ | ″ | ″ | 4 | ″ | Δ | ⊚ | 75 | 33 | ◯ |
| Comp. Ex. 1 | ″ | — | — | — | — | ◯ | X | 40 | 15 | X |
| Comp. Ex. 2 | ″ | — | — | — | 2 | ◯ | Δ | 49 | 19 | ◯ |
| Comp. Ex. 3 | ″ | Cationic (LUDOX CL) | 12 | 1 | — | ◯ | Δ | 60 | 22 | X |
| Comp. Ex. 4 | ″ | Cationic (LUDOX CL-P) | 22 | 1 | — | ◯ | Δ | 56 | 21 | X |
| Comp. Ex. 5 | ″ | Anionic (PL-2) | 20 | 1 | — | ◯ | Δ | 55 | 21 | X |
| Comp. Ex. 6 | ″ | Anionic (PL-2) | 20 | 1 | 2 | X | — | — | — | — |

TABLE 2

| | Composition of coagulation solution | | | | | | | Evaluation | | | | | |
|---|---|---|---|---|---|---|---|---|---|---|---|---|---|
| | | Colloidal silica | | | | | | Stability | | | | | |
| | Boric | | | | Primary | | Cationic | of coating | | | | | |
| | acid | | | | particle | | resin | color and | Cast | Image | | | Dye ink |
| | Content | | | | diamter | Content | Content | cagulation | coating | clarity | Gloss at | Water | optical |
| | (wt %) | Polarity | Model | pH | (nm) | (wt %) | (wt %) | solution | property | (%) | 20 degree | resistance | density |
| Ex. 11 | 4 | Cationic | CL-P | 3 | 22 | 2 | 1 | ◯ | ⊚ | 70 | 24 | ◯ | ◯ |
| Ex. 12 | 4 | Cationic | CL-P | 3 | 22 | 7 | 1 | ◯ | ◯~⊚ | 75 | 31 | ◯ | ◯~⊚ |
| Ex. 13 | 4 | Cationic | CL-P | 3 | 22 | 15 | 1 | ◯ | ◯ | 79 | 38 | ◯ | ⊚ |
| Ex. 14 | 4 | Cationic | CL | 3 | 12 | 6 | 1 | ◯ | ◯ | 77 | 30 | ◯ | ◯~⊚ |
| Ex. 15 | 1 | Cationic | CL-P | 3 | 22 | 6 | 1 | ◯ | ⊚ | 66 | 27 | ◯ | ◯ |
| Ex. 16 | 10 | Cationic | CL-P | 3 | 22 | 6 | 1 | ◯ | ◯ | 66 | 35 | ◯ | ◯ |
| Comp. Ex. 11 | 4 | — | — | — | — | — | 1 | ◯ | X | 40 | 10 | Δ | X |
| Comp. Ex. 12 | 4 | Cationic | CL-P | 3 | 22 | 1 | 1 | ◯ | Δ | 55 | 18 | ◯ | Δ |
| Comp. Ex. 13 | 4 | Cationic | CL-P | 3 | 22 | 16 | 1 | X | Δ | 80 | 40 | ◯ | ⊚ |
| Comp. Ex. 14 | 4 | Anionic | ST-30 | 10 | 15 | 2 | 1 | X | — | — | — | — | — |
| Comp. Ex. 15 | 4 | Anionic | PL-2 | 7 | 20 | 2 | 1 | X | — | — | — | — | — |

The data reported in Tables 1 and 2 clearly indicated that each Example had high optical density when a dye ink was recorded, excellent image clarity, glossiness, water resistance and operability.

In Examples 1 to 5, the higher the content of the cationic colloidal silica was, the higher the dye ink optical density, the image clarity and the glossiness were. However, when the content of the cationic colloidal silica was 3% or more, the stability of the coagulation tended to be somewhat decreased.

When Examples 1 to 5 were compared with Examples 6 to 10, Examples 1 to 5 where the cationic colloidal silica had a smaller mean primary particle diameter provided higher optical density and glossiness, but tended to have somewhat decreased stability of the coagulation agent.

In contrast, Comparative Example 1 containing no colloidal silica and no cationic resin had poor dye ink optical density, image clarity, glossiness and water resistance.

Comparative Example 2 containing no colloidal silica in the coagulation agent had good water resistance, but poor image clarity and glossiness.

Comparative Examples 3 to 5 containing no cationic resin in the coagulation agent had poor water resistance.

In Comparative Example 6 containing the anionic colloidal silica and the cationic resin, the coagulation agent was aggregated to inhibit coating so that inkjet recording medium could not be made.

Comparative Example 11 containing no cationic colloidal silica in the coagulation solution had poor dye ink optical density, image clarity, glossiness and cast coating property.

Comparative Example 12 containing less than 2% by weight of the cationic colloidal silica in the coagulation solution had poor glossiness. It is considered that a small amount of fine colloidal silica resided on the surface of the ink receiving layer to lower the effect of smoothing the surface of the ink receiving layer.

In Comparative Example 13 containing greater than 15% by weight of the cationic colloidal silica in the coagulation solution, the coagulation solution was aggregated to inhibit coating so that inkjet recording medium could not be made.

Also in Comparative Examples 14 and 15 containing the anionic colloidal silica and the cationic resin in the coagulation solution, the coagulation solution was aggregated to inhibit coating so that inkjet recording medium could not be made.

1. An inkjet recording medium comprising an ink receiving layer formed by applying a coating layer containing a pigment and a binder to at least one side of a support having air permeability, and applying a coagulation solution for coagulating the binder on a surface of the coating layer by a coagulation cast coating method, wherein a boron compound, a cationic resin and cationic colloidal silica contained in the coagulation solution exist on the surface of the ink receiving layer.

2. The inkjet recording medium according to claim 1, wherein the coagulation solution contains 0.5 to 4% by weight of the cationic colloidal silica.

3. The inkjet recording medium according to claim 1, wherein the primary particle diameter of the cationic colloidal silica is smaller than the primary particle diameter of the pigment.

4. The inkjet recording medium according to claim 2, wherein the primary particle diameter of the cationic colloidal silica is smaller than the primary particle diameter of the pigment.

5. The inkjet recording medium according to claim 1, wherein the pigment in the coating layer contains colloidal silica, the binder contains polyvinyl alcohol, the cationic colloidal silica in the coagulation solution has a primary particle diameter of 10 to 50 nm, and the boron compound is boric acid.

6. The inkjet recording medium according to claim 2, wherein the pigment in the coating layer contains colloidal silica, the binder contains polyvinyl alcohol, the cationic colloidal silica in the coagulation solution has a primary particle diameter of 10 to 50 nm, and the boron compound is boric acid.

7. The inkjet recording medium according to claim 3, wherein the pigment in the coating layer contains colloidal silica, the binder contains polyvinyl alcohol, the cationic colloidal silica in the coagulation solution has a primary particle diameter of 10 to 50 nm, and the boron compound is boric acid.

8. The inkjet recording medium according to claim 1, wherein gloss at 20 degree on the surface of the ink-receiving layer is 20% or more.

9. The inkjet recording medium according to claim 2, wherein gloss at 20 degree on the surface of the ink-receiving layer is 20% or more.

10. The inkjet recording medium according to claim 3, wherein gloss at 20 degree on the surface of the ink-receiving layer is 20% or more.

11. The inkjet recording medium according to claim 4, wherein gloss at 20 degree on the surface of the ink-receiving layer is 20% or more.

12. The inkjet recording medium according to claim 1, wherein the colloidal silica in the coating layer is anionic.

13. The inkjet recording medium according to claim 1, wherein the pigment in the coating layer further comprises wet synthetic amorphous silica having the specific surface area of 100-300 m²/g, and the mean secondary particle diameter of 1 to 4 μm.

14. The inkjet recording medium according to claim 1, wherein the coagulation solution contains a release agent.

15. The inkjet recording medium according to claim 1, wherein the support contains rosette type precipitated calcium carbonate having the ash content of 3-25% by weight according to JIS-P8251.

16. A method of manufacturing an inkjet recording medium comprising the steps of: applying a coating color for an ink receiving layer having a pH of 7 to 10 containing colloidal silica as a pigment and polyvinyl alcohol as a binder on at least one side of a support having air permeability to form a coating layer; applying a coagulation solution having a pH of 1 to 4 containing 2-15% by weight of the cationic colloidal silica having a primary particle diameter of 10 to 50 nm, 1 to 10% by weight of boric acid and a cationic resin while the coating layer is in a wet state; and forming the ink receiving layer by a coagulation cast coating method.
